(19) United States
(12) Patent Application Publication
(10) Pub. No.: US 2008/0288812 A1
(43) Pub. Date: Nov. 20, 2008

(54) CLUSTER SYSTEM AND AN ERROR RECOVERY METHOD THEREOF

(76) Inventors: Yuzuru Maya, Sagamihara (JP); Koji Ito, Yokohama (JP); Masaya Ichikawa, Sagamihara (JP); Takaaki Haruna, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/180,965

(22) Filed: Jul. 28, 2008

Related U.S. Application Data
(63) Continuation of application No. 10/998,938, filed on Nov. 30, 2004.

(30) Foreign Application Priority Data
Apr. 7, 2004 (JP) 2004-113381

(51) Int. Cl. G06F 11/00

(52) U.S. Cl. 714/4; 714/E11.022

(57) ABSTRACT

A cluster system including: a transmission side server cluster consisting of a plurality of computers; a receiving side server cluster consisting of a plurality of computers; and a network that interconnects both the transmission side server cluster and the receiving side server cluster, wherein an active-transmission computer which is included in the transmission side server cluster selects a standby-transmission computer from the computers in the transmission side server cluster, based on load information, and transmits a backup-copy of a message to the standby-transmission computer when the active-transmission computer transmits the message to a computer in the receiving side server, the stand-by transmission computer for back-up handling of the message in the event of occurrence of a fault in the active-transmission computer.

### CROSS REFERENCE TO RELATED APPLICATION

This is a continuation of U.S. application Ser. No. 10/998,938, filed Nov. 30, 2004. This application relates to and claims priority from Japanese Patent Application No. 2004-113381, filed on Apr. 7, 2004. The entirety of the contents and subject matter of all of the above is incorporated herein by reference.

### BACKGROUND OF THE INVENTION

The present invention relates in general to a cluster system and to a fault recovery method for use in the cluster system; and, more particularly, the invention relates to a system and method of the type described in which faster system failover and fault recovery are achieved upon occurrence of a fault.

JP-A No. H02 (1990)-186468 discloses a computer network control system in which a node computer observes the states of other nodes in real time by utilizing a node computer state information registration table that indicates whether or not other node computers are in a normal operation; and, if a fault occurs in a destination node to which it is communicating, automatic switching to an alternate destination node can take place.

JP-A No. 2000-47894 discloses a computer system where all nodes in the system operate to monitor a monitoring information repository on a disk that is shared across the nodes, and each node can determine a node to which failover is to be effected by dynamically selecting an alternative node, based on the monitoring information.

### SUMMARY OF THE INVENTION

In general, a cluster system is required such that all of the computers in the system perform processing such as message transactions, providing without a computer that is dedicated to a backup operation (that is used just in case of failure). In the cluster system, even if a fault occurs in one computer, the computer transfers a message to be processed or checkpoint data to another computer that operates normally to cause the alternate computer to take over the transaction subsequent to the fault by failover. Thereby, stopping of the whole cluster system operation can be prevented.

However, in the computer network control system disclosed in JP-A No. H02 (1990)-186468, if the system includes a plurality of transmission side computers, a failover between transmission side computers upon occurrence of a fault is not taken into consideration. In the computer system disclosed in JP-A No. 2000-47894, a node to which to effect failover can be determined from the monitoring information. However, the repository (such as checkpoint data) or resource information in the database stored on the shared disk must be referenced to perform the failover, and message retransmission is needed. Hence, it is impossible for this system to carry out a quick failover. In this system, when a computer selects a backup processing computer, the loads existing on the other computers are not exactly taken into consideration. Consequently, a heavier load is typically placed on only one of the servers as the loads vary.

In order to solve the above-described problems, the inventors propose a typical embodiment of this invention as described below.

A cluster system includes a transmission side server cluster consisting of a plurality of computers, one of which is selected as a transmitting computer and at least another one of which is selected as a standby computer. When the transmitting computer transmits a message it has received to a receiving side server, it also transmits the message to the standby computer, that was selected based on load information for all computers other than the transmitting one in the transmission side server cluster.

### BRIEF DESCRIPTION OF THE DRAWINGS

FIG. 1 is a block diagram of a cluster system according to a preferred embodiment of the invention;

FIG. 2 is a diagram illustrating an example of a three-layer cluster system configuration;

FIG. 3 is a diagram showing an example of the system configuration of each computer;

FIG. 4 illustrates an example of a load management table on an FEP server;

FIG. 5 illustrates an example of a load management table on an AP server;

FIG. 6 illustrates an example of a load management table on a DB server;

FIG. 7 is an operation timing diagram showing details of a message transaction;

FIG. 8 is a table showing classification of message transaction types;

FIG. 9(a) and FIG. 9(b) are separate flowcharts illustrating different procedures for value setting in the load management table;

FIG. 10 is a flowchart illustrating a procedure in which a transmitting computer determines a standby computer;

FIG. 11 is a flowchart illustrating a transaction procedure between a transmitting computer and a receiving computer in normal operation;

FIG. 12 is a flowchart illustrating a transaction procedure in the case where a fault occurs in the transmitting computer;

FIG. 13 is a flowchart illustrating steps of a procedure carried out when and after the transmitting computer recovers from the fault;

FIG. 14 is a diagram showing a distributed object system configuration; and

FIG. 15 is a diagram showing details of a transaction in the system shown in FIG. 14.

### DESCRIPTION OF THE PREFERRED EMBODIMENTS

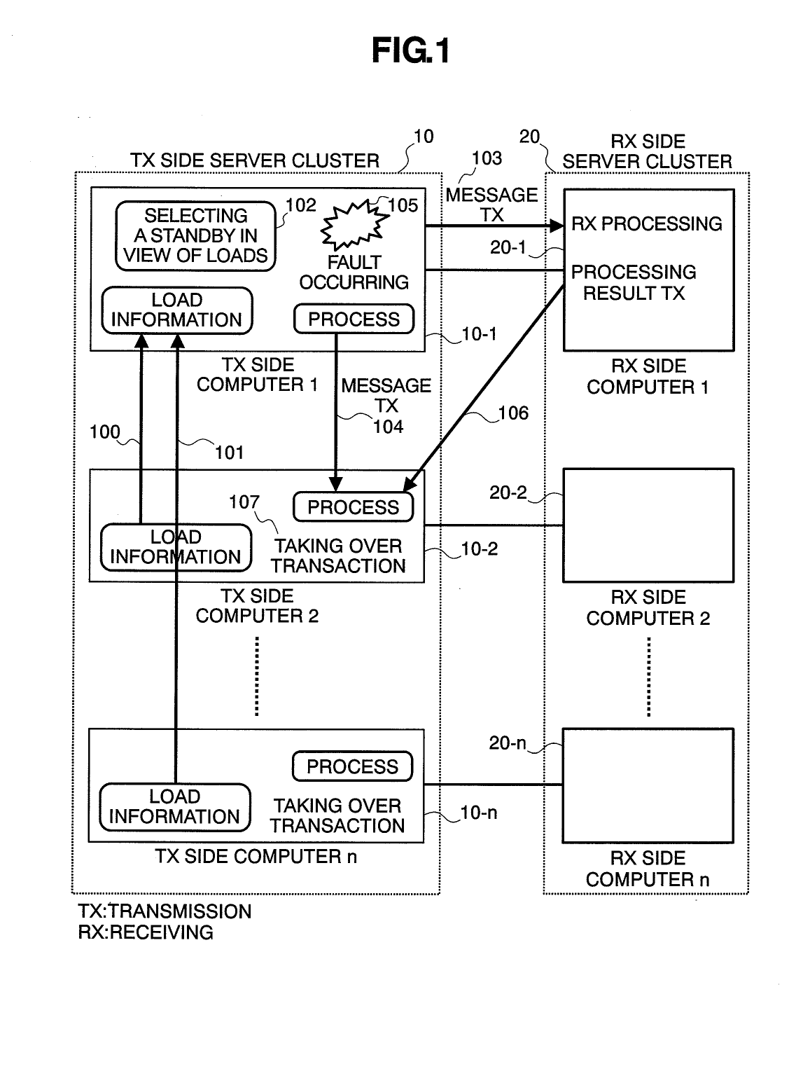

A best mode embodiment of the invention will be described hereinafter with reference to the accompanying drawings. FIG. 1 is a diagram showing a cluster system according to a preferred embodiment of the invention. This system consists of a transmission side server cluster 10 and a receiving side server cluster 20. The transmission side server cluster 10 consists of transmission side computers 1 (10-1) to n (10-n). The receiving side server cluster 20 consists of receiving side computers 1 (20-1) to n (20-n).

Here, a case is discussed where, when a transmission side computer 1 (10-1) transmits a message to a receiving side computer 1 (20-1), a fault occurs in the transmission side computer 1 (10-1), but the transaction is continued by any of the other transmission side computers (10-2 to 10-n).

Each of the remaining transmission side computers 2 to n (10-2 to 10-n) measures its load (e.g., CPU usage and memory usage) and sends the measured load information to the transmission side computer 1 (10-1) (steps 100 and 101). The transmission side computer 1 (10-1) selects a standby computer for backup processing, based on the load information (step 102). Here, it is assumed that a transmission side computer 2 (10-2) is selected for the backup. That is, any one of a plurality of transmission side computers may be selected as the transmitting computer that actually transmits a message, and one of the remaining computers which has the lowest load (its CPU usage and memory usage are lowest among the computers) is selected as the standby. Any of the plurality of transmission side computers can be selected as the one that actually transmits a message. In other words, any of the transmission side computers is capable of being the one that actually transmits a message.

Then, the transmission side computer 1 (10-1) parses the message to be transmitted, and, after checking the message properties, transmits the message to a receiving side computer 1 (20-1) (step 103). At this time, the transmission side computer 1 (10-1) transmits the message to the standby transmission side computer (standby computer) 2 for backup processing as well (step 104). When the transmission side computer 1 (10-1) transmits the message to the receiving side computer 1 (20-1), it transmits the information on the standby computer together with the message to the receiving side computer 1 (20-1).

When a fault occurs in the transmission side computer 1 (10-1) (step 105), both the transmission side computer 2 (10-2) and the receiving side computer 1 (20-1) detect the fault, and the receiving side computer 1 (20-1) transmits the message processing result back to the transmission side computer 2 (10-2) (step 106). Having received the processing result, the transmission side computer (standby computer) 2 (10-2) takes over the transaction; that is, it transmits the message received from the transmitting computer to the receiving side computer (step 107).

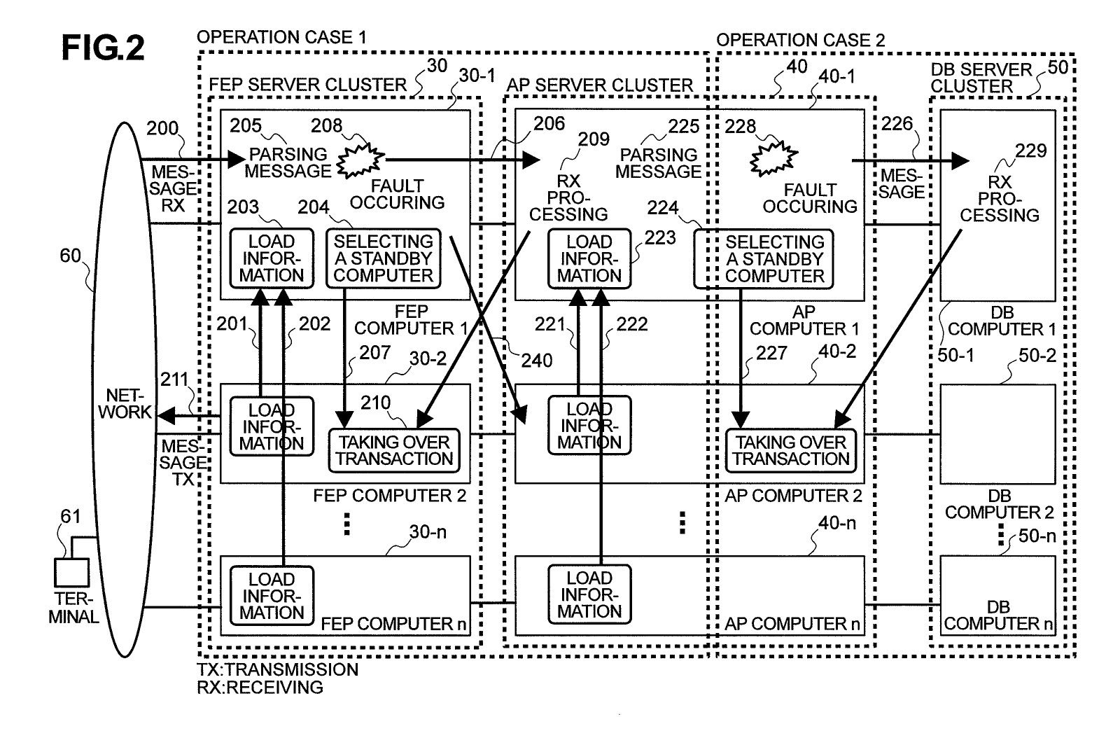

FIG. 2 is a diagram showing a three-layer cluster system configuration. This system is comprised of a Front End Processor (FEP) server cluster 30, an Application Processor (AP) server cluster 40, a Database (DB) server cluster 50, a network 60, and a terminal 61. The FEP server cluster 30 consists of FEP computers 1 to n (30-1 to 30-n). Likewise, the AP server cluster 40 consists of AP computers 1 to n (40-1 to 40-n) and the DB server cluster 50 consists of DB computers 1 to n (50-1 to 50-n).

Here, two cases of message transmission operation will be discussed. The first case of message transmission operation is performed between the FEP server cluster 30 and the AP server cluster 40, wherein the FEP server cluster 30 operates as the transmission side server cluster 10 and the AP server cluster 40 operates as the receiving side server cluster 20. The second case of message transmission operation is performed between the AP server cluster 40 and the DB server cluster 50, wherein the AP server cluster 40 operates as the transmission side server cluster 10, and the DB server cluster 50 operates as the receiving side server cluster 20.

In the first case of a message transmission operation, an FEP computer 1 (30-1) receives a message from a terminal 61 via the network 60 (step 200). The FEP computer 1 (30-1) transmits the received message to a receiving side computer 1 (40-1).

Here, a case is discussed where a fault occurs in the FEP computer 1 (30-1), but the transaction is continued by any of other FEP computers (30-2 to 30-n).

Each of the FEP computers 2 to n (30-2 to 30-n) measures its load (steps 201 and 202) and sends the measured load information to the FEP computer 1 (30-1) (step 203). Based on the load information, the FEP computer 1 (30-1) selects a standby computer for backup processing (step 204). Here, an FEP computer 2 (30-2) is selected for the backup.

The FEP computer 1 (30-1) parses the message and checks its properties (step 205). Then, the FEP computer 1 (30-1) transmits the received message to an AP computer 1 (40-1) (step 206). At this time, the FEP computer 1 (30-1) transmits the message to the standby FEP computer 2 (30-2) for backup processing as well (step 207).

When a fault occurs in the FEP computer 1 (30-1) (step 208), both the FEP computer 2 (30-2) and the AP computer 1 (40-1) detect the fault and the AP computer 1 (40-1) transmits the message processing result back to the FEP computer 2 (30-2) (step 209). Having received the processing result, the FEP computer 2 (30-2) takes over the transaction (step 110) and transmits the processing result message to the terminal 61 via the network 60 (step 211).

In the second case of a message transmission operation, the AP computer 1 (40-1) transmits a message to a receiving side DB computer 1. Here, a case is discussed where a fault occurs in the AP computer 1 (40-1), but the transaction is continued by any of the other AP computers (40-2 to 40-n).

The AP computers constitute transmission side computers to the DB computers and constitute receiving side computers for receiving a transmission from the FEP computers. In this case, the AP computer 1 is a transmission side computer relative to a DB computer and a receiving side computer relative to an FEP computer. Therefore, a fault occurring in the AP computer affects both the FEP computer and the DB computer.

Each of the AP computers 2 (40-2) to n (40-n) measures its load (steps 221 and 222) and transmits the measured load information to the AP computer 1 (40-1) (step 223). Based on the load information, the AP computer 1 (40-1) selects a standby computer for backup processing (step 224). Here, an AP computer 2 (40-2) is selected for the backup.

The AP computer 1 (40-1) parses the message and checks its properties (step 225). Then, the AP computer 1 transmits the message to a DB computer 1 (step 226). At this time, the AP computer 1 transmits the message to the standby AP computer 2 for backup processing as well (step 227).

When a fault occurs in the AP computer 1 (40-1) (step 228), both the AP computer 2 (40-2) and the DB computer 1 (50-1) detect the fault, and the DB computer 1 (50-1) transmits the message processing result back to the AP computer 2 (40-2) (step 229). Having received the processing result, the AP computer 2 (40-2) takes over the transaction (step 230).

On the other hand, when the FEP computer detects the fault in the AP computer, it retransmits the message to an AP computer having the lowest load among the AP computers that operate normally (step 240).

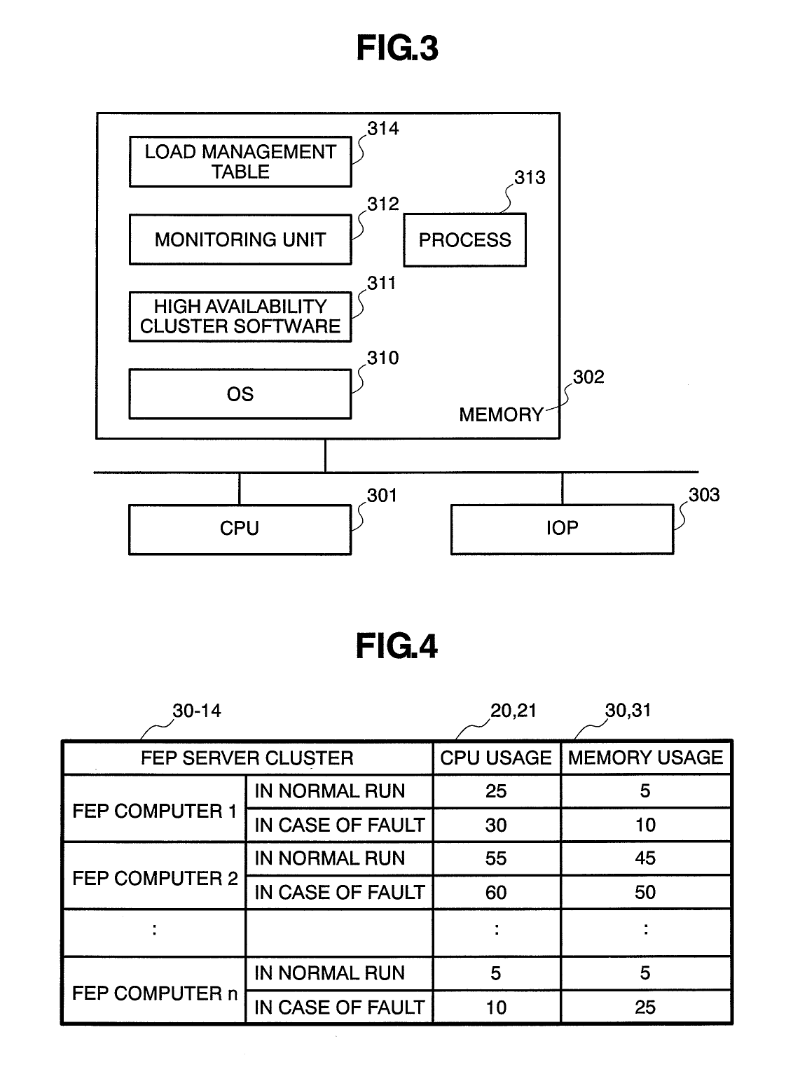

FIG. 3 is a diagram showing the system configuration of each of the above computers. Each computer is comprised of a Central Processing Unit (CPU) 301, a memory 302, and an Input Output Processor (IOP) 303. In the memory 302, an Operating System (OS) 310, high-availability cluster software 311, a monitoring unit 312, a load management table 314, and process software 313 are stored.

The high-availability cluster software 311 performs the following processes: fault detection by checking whether the computers operate normally; a failover to standby in case of a fault occurring in a computer; and the transmitting and receiving of load information to/from other computers. The monitoring unit 312 obtains the load information and stores it into the load management table 314. The above-described suite of software resides on every computer.

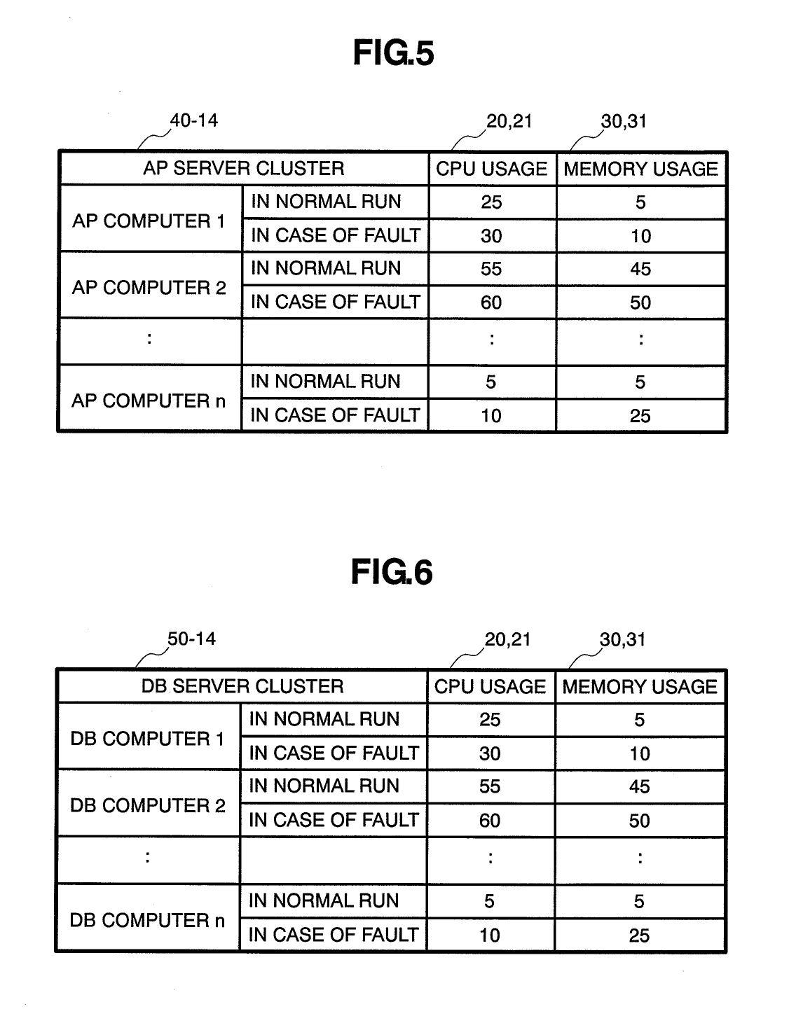

FIG. 4 illustrates a load management table 30-14 on an FEP server. FIG. 5 illustrates a load management table 40-14 on an AP server. FIG. 6 illustrates a load management table 50-14 on a DB server.

As shown in these figures, on the servers in the FEP server cluster 30, the servers in the AP server cluster 40, and the servers in the DB server cluster 50, the tables for management of the loads on the servers in the cluster are prepared respectively. All of the computers in the cluster have load management table in which the CPU usages and current memory usages of other computers are retained at all times.

The load management table is intended to manage the CPU usages and memory usages separately in a normal run and in case of a fault. In the state of fault-free operation, the CPU usages and memory usages in normal run apply. When a fault occurs in a computer, the CPU usages and memory usages in case of a fault apply. The values in “in normal run” in FIGS. 4, 5, and 6 represent the current CPU usages 20 and current memory usages 30 of the computers during normal operation.

When a fault occurs in a computer, its alternate computer takes over the transaction during which the fault has occurred. Due to taking over the transaction, both the CPU usage and the memory usage of the alternate computer increase. The values “in case of fault” in FIGS. 4, 5, and 6 represent the CPU usages 21 and memory usages 31 of the computers in consideration of taking over the transaction in case of a fault.

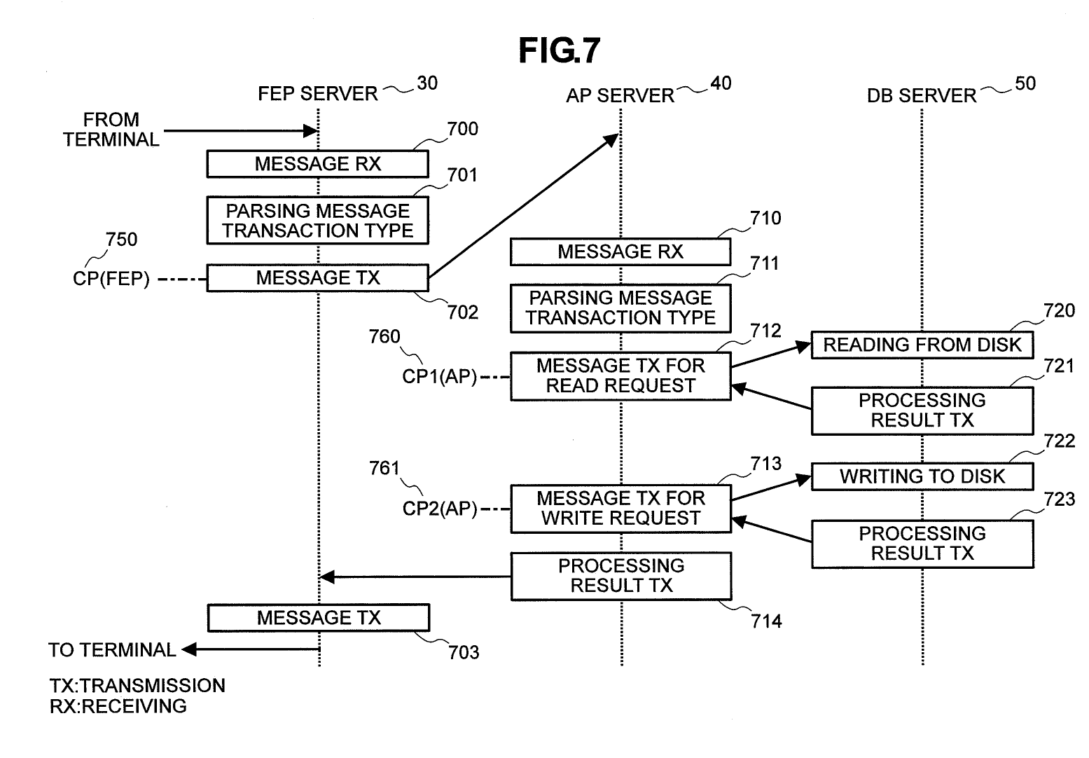

FIG. 7 is a diagram showing details of a message transaction. When an FEP server 30 computer receives a message from a terminal 61 (step 700), it parses the message (step 701) and transmits it to an AP server (step 702).

The AP server 40 receives the message (step 710) and parses it (step 711). Then, the AP server sends to a DB server 50 a read request from a disk (step 712) or a write request (step 713) to a disk.

When the DB server 50 receives a read request from a disk, it executes the reading (step 720) and returns the result of the reading to the AP server 40 (step 721). When the DB server 50 receives a write request to a disk, it executes the writing (step 722) and returns the result of the writing to the AP server 40 (step 723).

When the AP server 40 receives the processing result from the DB server 50, it transmits the writing result back to the FEP server 30 (step 714). Then, the FEP server 30 returns the processing result to the terminal (step 703).

Here, a checkpoint CP is defined. A checkpoint CP can be set at any step of a transaction to shorten the system recovery time. Checkpoint setting allows for the following operations. If a fault occurs before a first checkpoint, the message transaction is re-executed from the beginning. If a fault occurs after the first checkpoint, the transaction is re-executed from the most recent checkpoint. For instance, checkpoints are set as follows. On the FEP server 30, a checkpoint CP (FEP) 750 is set at the point of time when the FEP server transmits a message (step 702). On the AP server 40, a checkpoint is set at the point of time when the AP server sends a read request from a disk (step 712) or a write request to a disk (step 713). However, a checkpoint is not set for processing by the DB server 50.

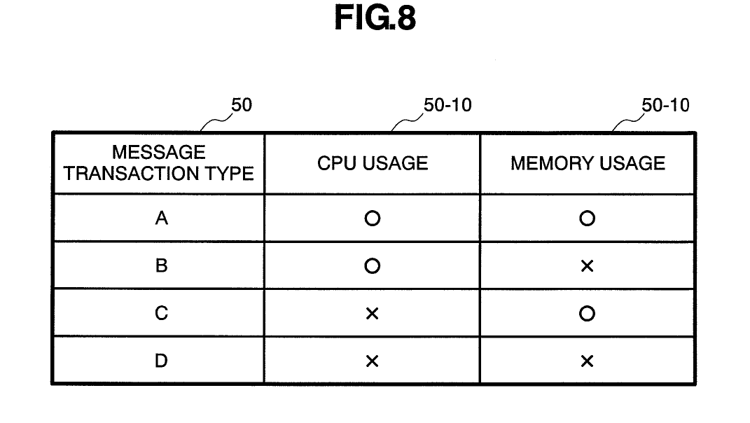

FIG. 8 identifies the classification of message transaction types. In the example of this figure, messages are classified into transaction types, according to the CPU usage and the memory usage required. Message transaction A requires both CPU and memory resources. Message transaction type B mainly requires CPU processing. Message transaction C mainly requires memory resources. Message transaction D does not require CPU and memory resources significantly. In FIG. 8, a mark O denotes that the transaction type requires it and a mark X denotes that the transaction type does not require it significantly.

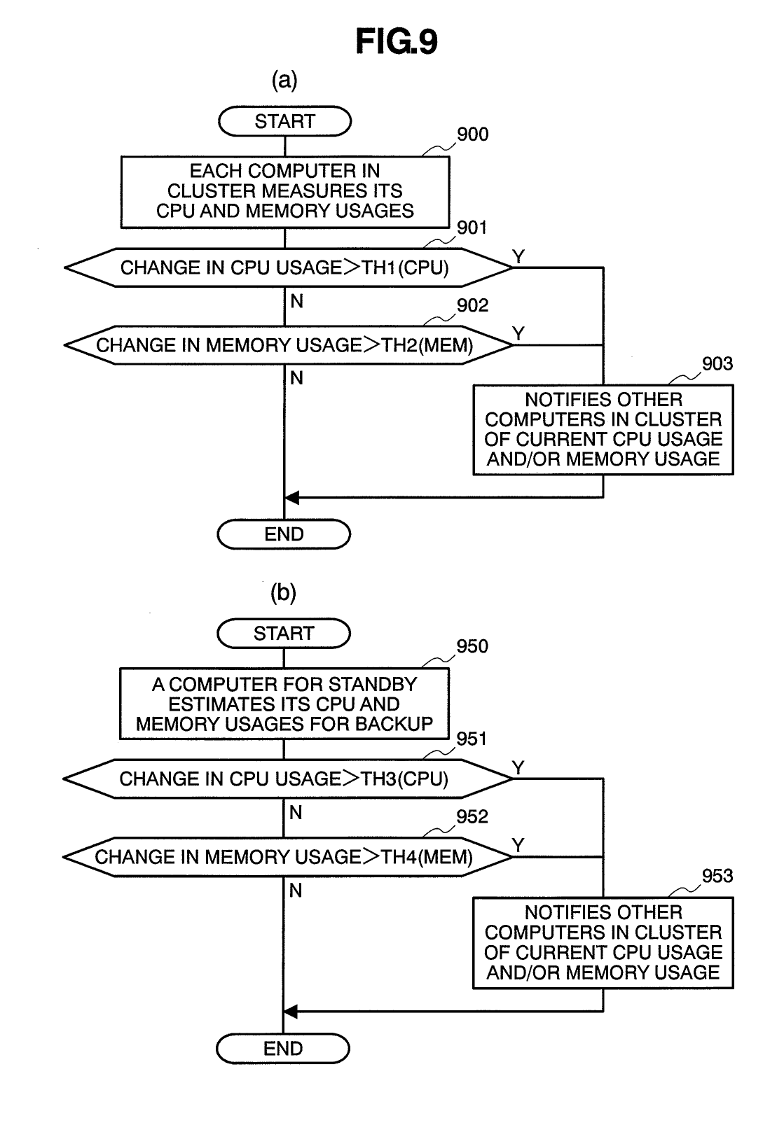

FIG. 9(a) and FIG. 9(b) are separate flowcharts to explain different procedures for value setting in the load management table. As shown in FIGS. 4 through 6, the values of CPU usages and memory usages of the computers in the cluster in a normal run and in the case of a fault are stored in the load management table.

Using FIG. 9(a), first, the procedure used for setting the CPU and the memory usage values in a normal run in the table will be described. Each of all transmission side computers measures its CPU and memory usages periodically at the start or end of a message transaction (step 900). If a change in the CPU usage from the previous measurement is equal to or more than a predetermined threshold (TH1), the computer notifies other computers in the cluster of the current CPU usage and memory usage (step 903). If the change is less than the predetermined threshold (TH1), it is judged that substantially no change has occurred in the load and the computer sends no notification to the other computers.

Similarly, if a change in the memory usage from the previous measurement is equal to or more than a predetermined threshold (TH2), the computer notifies other computers in the cluster of the current memory usage (step 903). If the change is less than the threshold (TH2), it is judged that substantially no change has occurred in the load and the computer sends no notification to the other computers. In this way, the transmission side computers can store the CPU and memory usage values of other computers into the load management table.

Next, using FIG. 9(b), the procedure for setting the CPU and the memory usage values in the case of a fault in the table will be described. Each of all transmission side computers estimates its CPU usage and memory usage for backup each time it receives a backup copy message, or it is notified of the end of backup copy message transmission (step 950). That is, each transmission side computer estimates how much the CPU usage and the memory will usage increase by backup in addition to the CPU and memory usages in a normal run when taking over the transaction of the message that it must back up and calculates the CPU usage and memory usage.

If a change in the thus calculated CPU usage from the previous measurement is equal to or more than a predetermined threshold (TH3), the computer notifies the other computers in the cluster of the CPU usage and memory usage (step 953). If the change is less than the threshold (TH3), it is judged that substantially no change has occurred in the load and the computer sends no notification to other computers.

Similarly, if a change in the thus calculated memory usage from the previous measurement is equal to or more than a predetermined threshold (TH4), the computer notifies the other computers in the cluster of the memory usage (step 953). If the change is less than the threshold (TH4), it is judged that substantially no change has occurred in the load and the computer sends no notification to the other computers. In this way, the transmission side computers can store the CPU and memory usage values of other computers into the load management table.

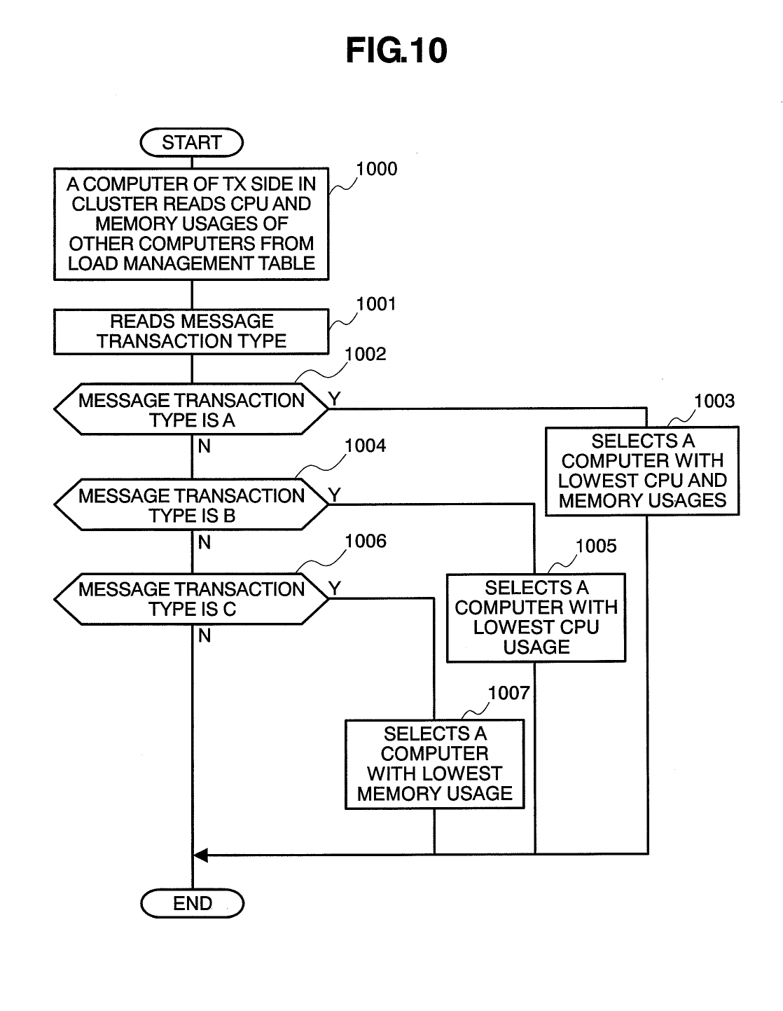

FIG. 10 is a flowchart showing a procedure in which a transmitting computer determines a standby computer. This process is performed at the start of a message transaction. First, the transmitting computer (a computer on the transmission side in the cluster) refers to the load management table and reads the CPU and memory usage values of the other computers in the cluster from the table (step 1000). Next, the transmitting computer identifies the type of the message transaction (step 1001). If the message transaction type is A (step 1002), the transmitting computer selects a computer with the lowest CPU and memory usages as the standby (step 1003). If the message transaction type is B (step 1004), the transmitting computer selects a computer with the lowest CPU usage as the standby (step 1005). If the message transaction type is C (step 1006), the transmitting computer selects a computer with the lowest memory usage as the standby (step 1007).

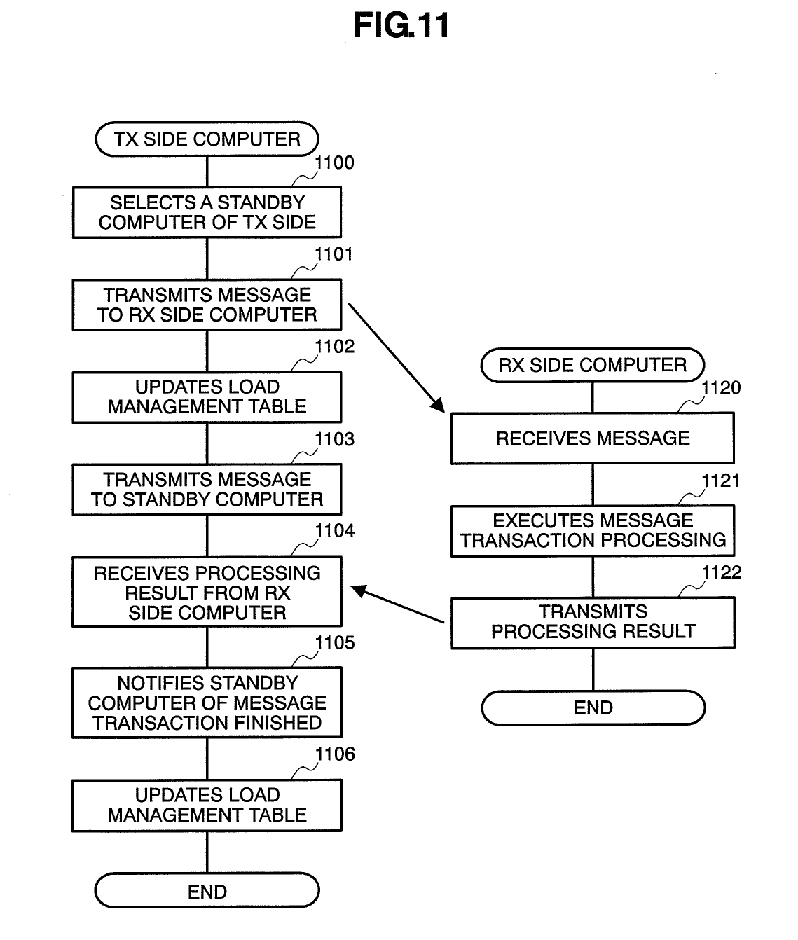

FIG. 11 is a flowchart showing a transaction procedure between a transmitting computer and a receiving computer in a normal operation. First, the transmitting computer selects another transmission side computer (standby computer) for backup processing (step 1100). This selection can be performed through the procedure shown in FIG. 10. Next, the transmitting computer transmits a message to the receiving computer (step 1101). Then, the transmitting computer updates the CPU and memory usage values in the load management table, according to the type of message transaction (step 1102). At this time, the transmitting computer transmits the message to the standby computer in the transmission side cluster as well (step 1103).

On the other hand, the receiving computer receives the message (step 1120), executes the received message transaction processing (step 1121), and, after completing the processing, transmits the processing result back to the transmitting computer (step 1122).

The transmitting computer receives the processing result (step 1104) and notifies the standby computer that the message transaction is finished (step 1105). At the end of the message transaction, the transmitting computer updates the CPU and memory usage values in the load management table (step 1106). The above-described steps 1102 and 1106 can be performed through the process described with reference to FIGS. 9(a) and 9(b).

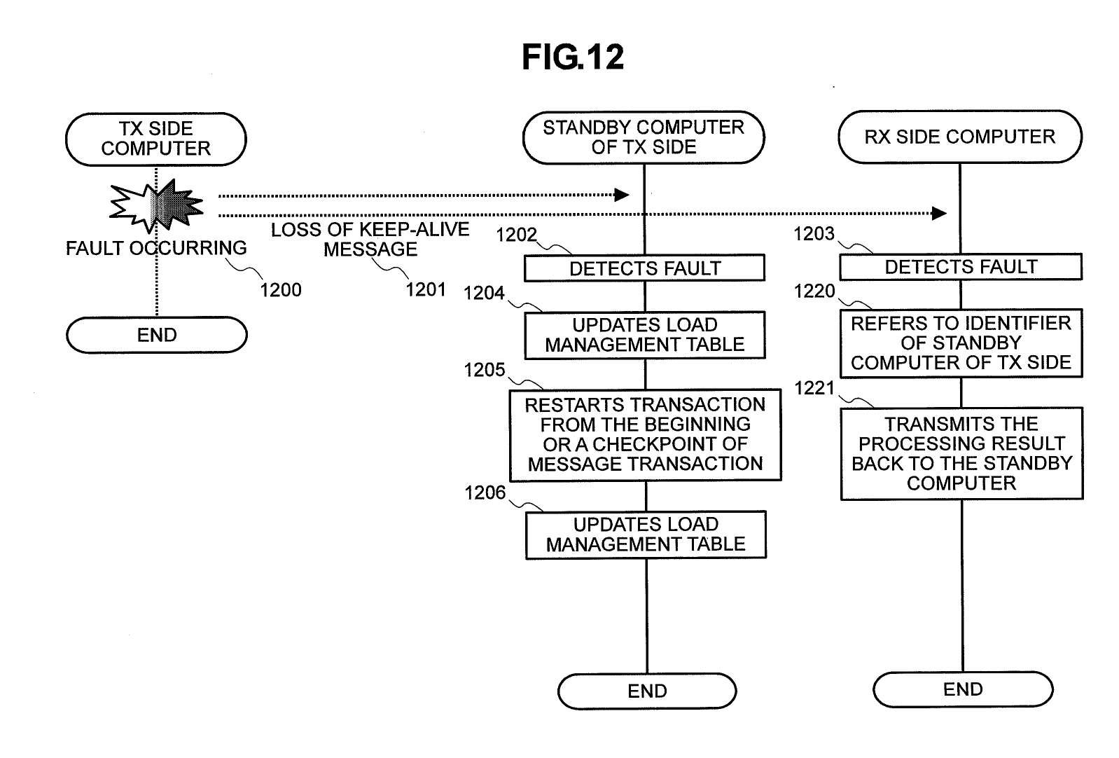

FIG. 12 is a flowchart to explain a transaction procedure in the case where a fault occurs in the transmitting computer. First, assume that a fault occurs in the transmitting computer (step 1200). Both the standby computer on the transmission side and the receiving computer detect the fault (steps 1202 and 1203) by detecting the loss of a keep-alive message (step 1201) of the high availability cluster software.

After the fault detection, the standby computer on the transmission side applies the values in the case of a fault in the load management table, not the values in a normal run in the table. The standby computer updates the load management table with load information in the case of the fault (step 1204). Next, the standby computer restarts the message transaction from the beginning or the most recent checkpoint (step 1205). At the end of the message transaction, the standby computer updates the load management table again (step 1206).

On the other hand, the receiving computer restarts the transaction, referring to the message identifier it received as checkpoint data (step 1220). Then, it transmits the processing result back to the standby computer on the transmission side (step 1221). The steps 1204 and 1206 can be performed through the process described with reference to FIGS. 9(a) and 9(b).

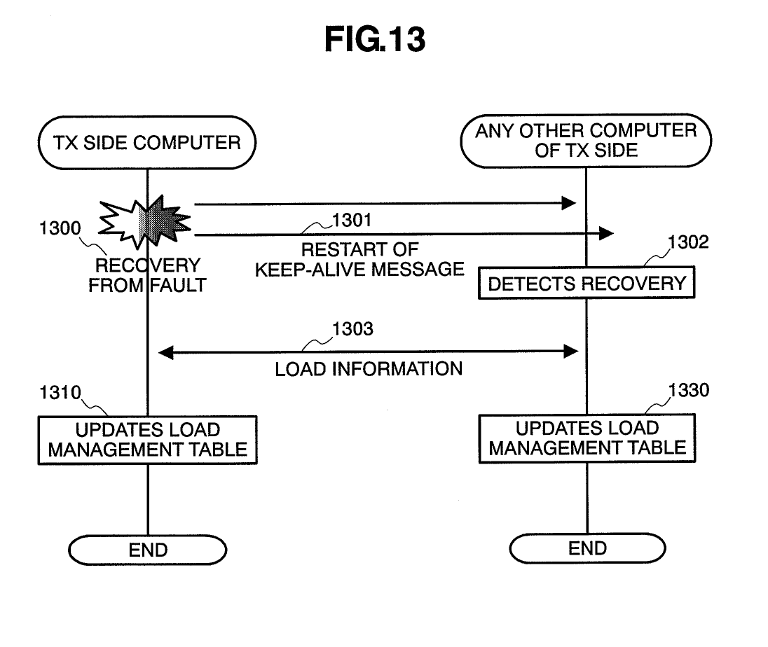

FIG. 13 is a flowchart showing steps of a procedure carried out when and after the transmitting computer recovers from the fault. First, assume that the transmitting computer recovers from the fault (step 1300). Both the standby computer on the transmission side and the receiving computer detect the recovery (step 1302) by detecting the restart of the keep-alive message (step 1301) of the high availability cluster software. Then, load information is exchanged between the transmitting computer and the standby computer exchange, and the load management table is updated.

The transmitting computer that has recovered from the fault obtains load information from other transmission side computers by the high availability cluster software and updates the CPU and memory usage values in a normal run and, in the case of a fault, in the load management table (step 1310).

On the other hand, any other transmission side computer obtains load information from other transmission side computers by the high availability cluster software and updates the CPU and memory usage values in a normal run and in the case of a fault for the computer that has recovered from the fault (step 1330). After the recovery from the fault, the CPU and memory usage values in normal run apply. The steps 1310 and 1330 can be performed through the process described with reference to FIGS. 9(a) and 9(b).

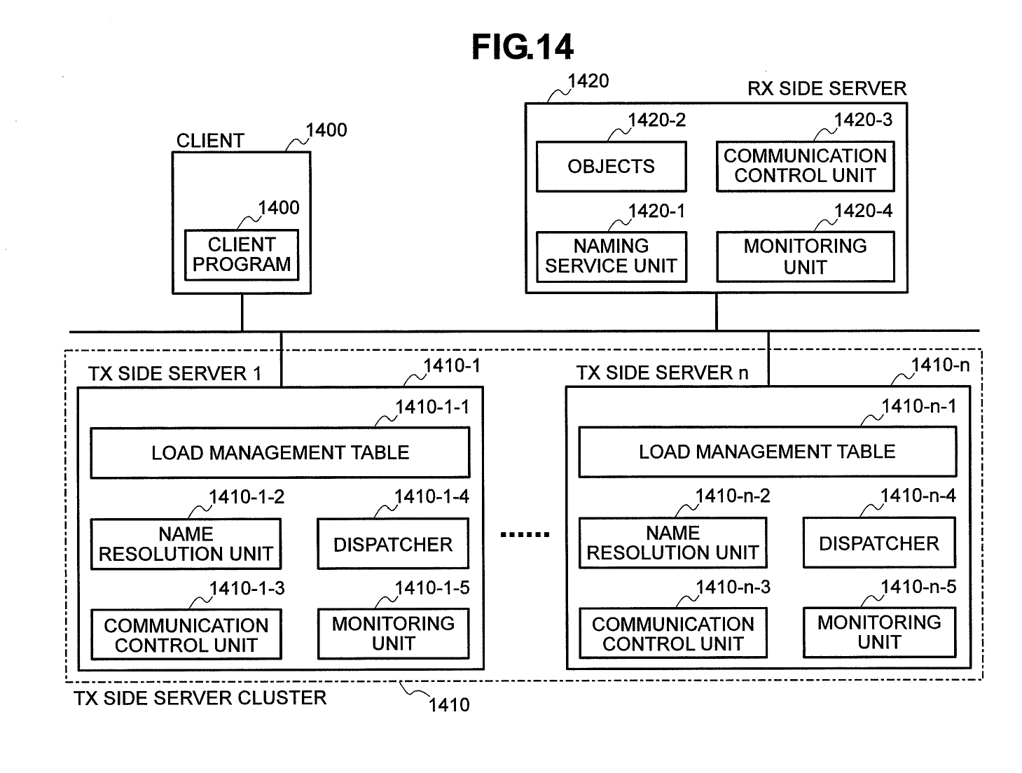

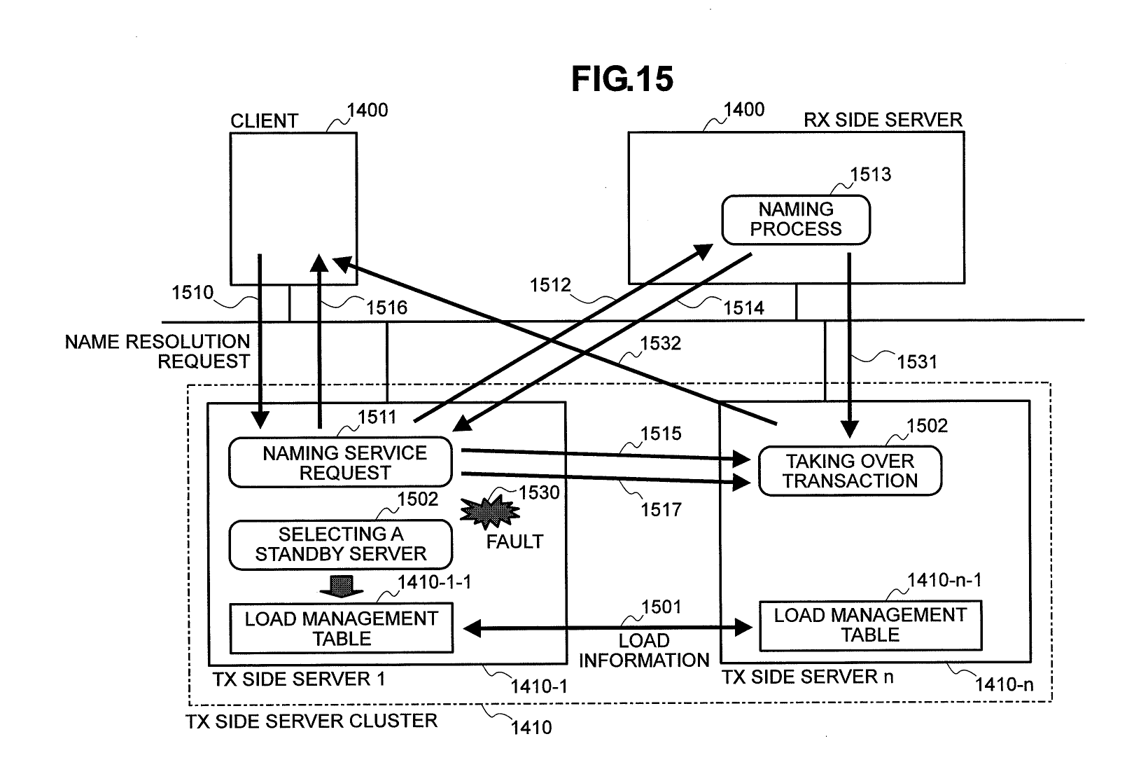

Next, using FIGS. 14 and 15, an example of application of the invention to a distributed object system will be described. A transaction is carried out in the distributed object system is as follows. When a client requests a predefined service (by executing a program or object), the client first sends a query for resolving the name of an object to a server for naming the service and receives the reference to the object. The client sends a request for service to a particular server designated by the reference to the object and, from that server, receives the result of processing obtained by the object execution by calling a method for the object on the server. In this way, a service is provided through message exchange between servers.

FIG. 14 is a diagram showing a distributed object system configuration. This system is comprised of a client 1400, a transmission side server cluster 1410 consisting of a plurality of transmission side servers and a receiving side server 1420.

The client 1400 has a client program 1401 and sends a query and a processing request to the transmission side server cluster 1410.

The transmission side server cluster 1410 consists of transmission side computers 1 (1410-1) to n (1410-n). The transmission side server cluster 1410 receives a request from the client 1400, parses the request, and sends a query and a processing request to the receiving side server 1420.

A transmission side computer 1 (1410-1) is comprised of a load management table 1410-1-1, a name resolution unit 1410-1-2, a communication control unit 1410-1-3, a dispatcher 1410-1-4, and a monitoring unit 1410-1-5. The load management table 1410-1-1 records object allocation information. The object information management table 1410-1-1 stores the load states of other transmission side computers. The name resolution unit 1410-1-2 generates a query for resolving the name of an object. The communication control unit 1410-1-3 performs communication with the other server devices and the client through a communication device. The dispatcher 1410-1-4 reads load information from the load management table when determining a standby transmission side server, determines a transmission side server having the lowest load as the standby one, and transmits a request to this transmission side server. It also monitors the operating statuses of other server devices.

Other transmission side computers 2 (1410-2) to n (1410-n) have the same configuration as the transmission side computer 1 (1410-1).

The receiving side server 1420 receives a query from the transmission side server cluster 1410 and executes the processing requested. The receiving side server 1420 is comprised of a naming service unit 1420-1, objects 1420-2, a communication control unit 1420-3, and a monitoring unit 1420-4.

The naming service unit 1420-1 executes object name resolution. Each of the objects 1420-2 carries out a predefined service. The communication control unit 1420-3 and the monitoring unit 1420-4 have the same functions as those on the transmission side server devices, respectively.

FIG. 15 is a diagram showing details of a transaction. Here, a transaction for name resolution will be discussed by way of example. First, the client 1400 sends a request for service to a transmission side server 1410. The transmission side server 1410 transmits load information to the other transmission side servers. Also, the transmission side server always has load information for other transmission side servers (step 1501).

The client 1400 sends a request for name resolution to the transmission side server 1410-1 (step 1510). Having received the name resolution request from the client 1400, the transmission side server 1410-1 selects a server having the lowest load as a standby transmission side server 1410-n. The transmission side server 1410-1 transmits a naming service request to the receiving side server 1420 (step 1512). The receiving side server 1420 performs the naming and returns the result of the naming to the transmission side server 1410-1 (step 1514).

The transmission side server 1410-1 selects a standby transmission side server 1410-n and transmits the message received from the client 1400 to the standby transmission side server 1410-n so that the standby server can take over the transaction immediately even if a fault occurs in the transmission side server 1410-1 (step 1515).

When the transmission side server 1410-1 receives the processing result from the receiving side server 1420, it transmits this result back to the client 1400. Finally, the transmission side server 1410-1 makes sure that this request transaction has finished, notifies the standby transmission side server 1410-n that the transaction has finished, and deletes the message from the client 1400 (step 1517).

By the way, when a fault occurs in the transmission side server 1410-1 (step 1530), the monitoring unit 1420-4 of the receiving side server detects that condition and the receiving side server 1420 transmits the processing result back to the standby transmission side server 1410-n (step 1531). The standby transmission side server 1410-n transmits the processing result back to the client 1400 (step 1532). Even if the client sends a request for an object, the transaction flow is the same. Even if a fault occurs in the transmitting server, the transaction can be continued by putting a transmission side server with the lowest load in service as the standby server.

As discussed above, according to the present embodiment, in a cluster system comprising a transmission side server cluster and a receiving side server cluster, a transmission side computer monitors the load states of the other transmission side computers. The transmitting computer selects a computer with the lowest load as a standby computer for backup processing and transmits a transaction message to this standby computer as well. Should a fault occur in the transmitting computer, the receiving side computer returns the message transaction processing result to the standby computer for backup processing. In response to this processing result message, the standby computer for backup takes over the transaction. Thus, because the transmitting computer need not retransmit the message to the standby computer, the system recovery time can be shortened. Even in the case of a fault occurring, backup can be executed on a per-message basis in a transaction by a computer with an optimum load for backup at all times. Thus, it is possible to avoid the problem that loads are concentrated on a particular computer that takes over the transaction.

Because of having the constitution described hereinbefore, the present invention can provide a cluster system that enables faster system recovery by selecting a standby computer that is optimum for backup processing.

What is claimed is:

1. A cluster system comprising:
a transmission side server cluster consisting of a plurality of computers;
a receiving side server cluster consisting of a plurality of computers; and
a network that interconnects both the transmission side server cluster and the receiving side server cluster,
wherein an active-transmission computer which is included in the transmission side server cluster selects a standby-transmission computer from the computers in the transmission side server cluster, based on load information, and transmits a backup-copy of a message to the standby-transmission computer when the active-transmission computer transmits the message to a computer in the receiving side server, the stand-by transmission computer for back-up handling of the message in the event of occurrence of a fault in the active-transmission computer.
